(19) United States
(12) Patent Application Publication
(10) Pub. No.: US 2009/0266956 A1
(43) Pub. Date: Oct. 29, 2009

(54) Holder for socket

(76) Inventor: Tsai-Chien Shih, Taichung City (TW)

Correspondence Address: Dr. BANGER SHIA, 102 Lindencrest Ct., Sugar Land, TX, 77479-5201, US

(21) Appl. No.: 12/110,338

(22) Filed: Apr. 27, 2008

(51) Int. Cl. F16L 3/08

(52) U.S. Cl. 248/221.11

(57) ABSTRACT

A holder is disclosed to hold a socket onto a hanger. The holder includes a socket-engaging device, a locking device and a hanger-engaging device. The socket-engaging device includes a V-shaped body and a block. The V-shaped body includes a first branch and a second branch elastically movable towards the first branch so that the V-shaped body can be inserted into the socket. The block is formed on the second branch for abutment against the socket when the V-shaped body is disposed in the socket. The locking device includes a groove defined in the first branch of the V-shaped body and a tab extended from the second branch of the V-shaped body. The tab can be inserted into the groove so that the elastic V-shaped body is expanded, and the block is firmly located against the socket. The hanger-engaging device includes a dovetail groove for receiving a dovetail formed on the hanger.

### BACKGROUND OF INVENTION

1. Field of Invention

The present invention relates to a holder for a socket of a socket wrench.

2. Related Prior Art

Socket wrenches are common tools. A socket wrench includes a handle and a set of sockets. A selected one of the sockets is engaged with the handle for driving a threaded bolt or nut for example. In display, such sockets are often disposed in containers. Customers search the containers for sockets. The look is massy. Moreover, such sockets could easily be stolen.

To make the display of such sockets aesthetic and secure, there are various types of hangers. Such a hanger is used to hang such a socket. Such a hanger is equipped with an anti-theft magnetic code bar. However, such a hanger cannot be used to hang such a socket when such a hanger is removed from such a socket. At this instant, such a hanger is garbage and must be disposed of, and this is not environmentally friendly. On the other hand, such a socket cannot be hung or held in position.

To hang a socket in a shop and in a residence, the applicant of the present invention has invented a hanger to which Taiwanese Patent M315639 has been granted.

Therefore, the present invention is intended to obviate or at least alleviate the problems encountered in prior art.

### SUMMARY OF INVENTION

It is the primary objective of the present invention to provide a holder for a socket of a socket wrench in a shop and in a residence.

According to the present invention, a holder is disclosed to hold a socket onto a hanger. The holder includes a socket-engaging device, a locking device and a hanger-engaging device. The socket-engaging device includes a V-shaped body and a block. The V-shaped body includes a first branch and a second branch elastically movable towards the first branch so that the V-shaped body can be inserted into the socket. The block is formed on the second branch for abutment against the socket when the V-shaped body is disposed in the socket. The locking device includes a groove defined in the first branch of the V-shaped body and a tab extended from the second branch of the V-shaped body. The tab can be inserted into the groove so that the elastic V-shaped body is expanded, and the block is firmly located against the socket. The hanger-engaging device includes a dovetail groove for receiving a dovetail formed on the hanger.

Other objectives, advantages and features of the present invention will become apparent from the following description referring to the attached drawings.

### BRIEF DESCRIPTION OF DRAWINGS

The present invention will be described via detailed illustration of the preferred embodiment referring to the drawings.

FIG. 1 is a perspective view of a holder for a socket of a socket wrench according to the preferred embodiment of the present invention.

FIG. 2 is a perspective view of a socket of a socket wrench and the holder shown in FIG. 1.

FIG. 3 is a cross-sectional view of the socket and the holder shown in FIG. 2.

FIG. 4 is a cross-sectional view of the socket held by the holder shown in FIG. 3.

FIG. 5 is a perspective view of four sockets held by four holders as shown in FIG. 4 and engaged with a hanger shown in phantom lines.

FIG. 6 is a perspective view of a socket held by a holder as shown in FIG. 4 and engaged with another hanger shown in phantom lines.

### DETAILED DESCRIPTION OF PREFERRED EMBODIMENT

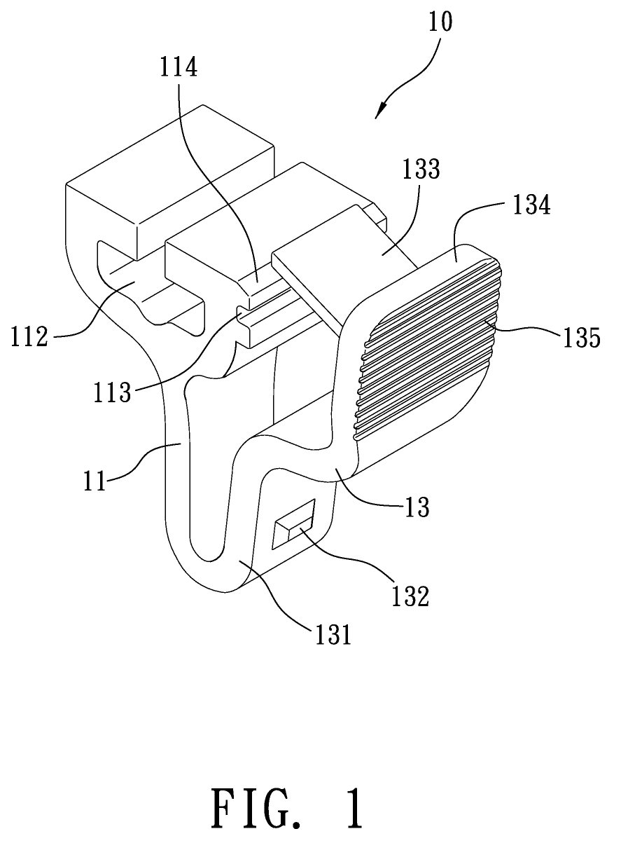

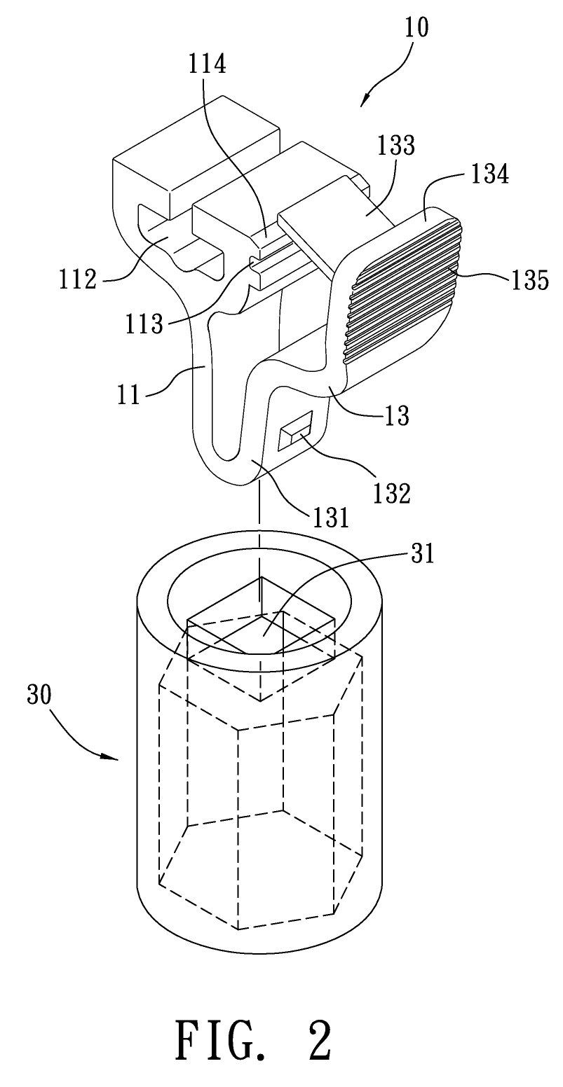

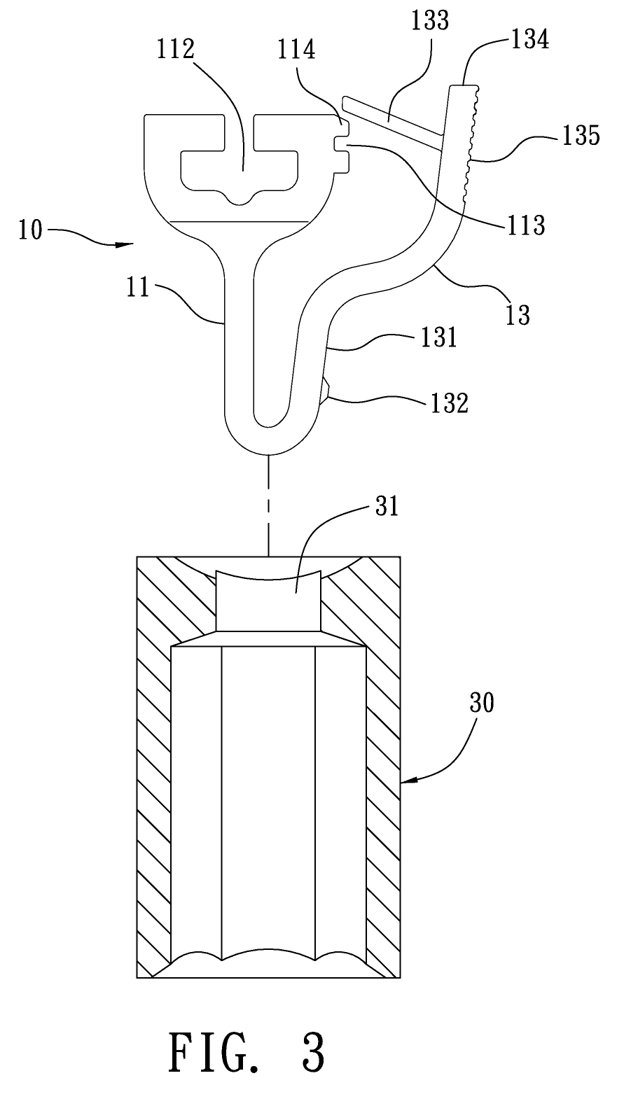

Referring to FIGS. 1 to 3, there is shown a holder 10 for a socket 30 of a socket wrench according to the preferred embodiment of the present invention. The holder 10 includes a socket-engaging device, a locking device and a hanger-engaging device. The socket-engaging device includes a V-shaped (or U-shaped) body including a first branch 11 and a second branch 13. Obviously, the V-shaped body is elastic, i.e., the first branch 11 and the second branch 13 can be pivoted towards each other. A block 132 is formed on the second branch 13. The block 132 is in the form of a trapezoid.

The locking device includes an extensive element 133 extended from the second branch 13, a recess 113 defined in the first branch 11 and a slope 114 formed on the first branch 11. Preferably, the extensive element 133 is a tab, and the recess 113 is a groove. The groove 113 is located lower than the slope 114. The tab 133 is normally disposed outside the groove 113. The tab 133 can be moved on the slope 114 and latter into the groove 113 so that the first branch 11 and the second branch 13 are pushed from each other, i.e., the V-shaped body is expanded. The second branch 13 is formed with a button 134 opposite to the tab 133. The button 134 includes grooves 135 defined therein. The button 134 is formed for the maneuvering of the tab 133,

The hanger-engaging device includes a dovetail groove 112 defined in the first branch 11.

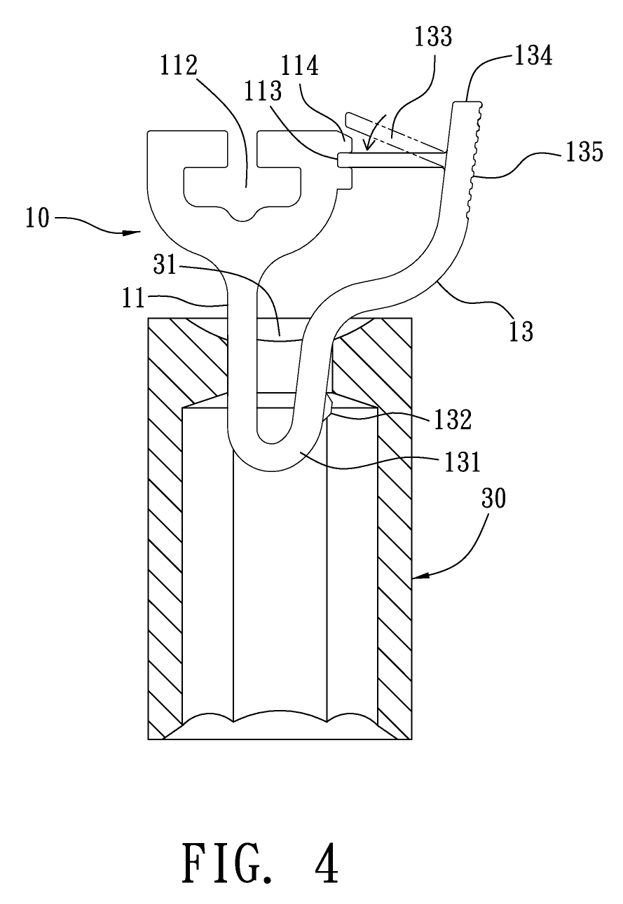

Referring to FIG. 4, the V-shaped body of the locking device is inserted the socket 30 through an aperture 31 defined in the socket 30. The block 132 is located against a portion of the socket 30 near the aperture 31. The tab 133 is inserted in the groove 113. That is the V-shaped is expanded. Thus, the block 132 is firmly located against the socket 30. That is, the socket 30 is firmly connected to the holder 10.

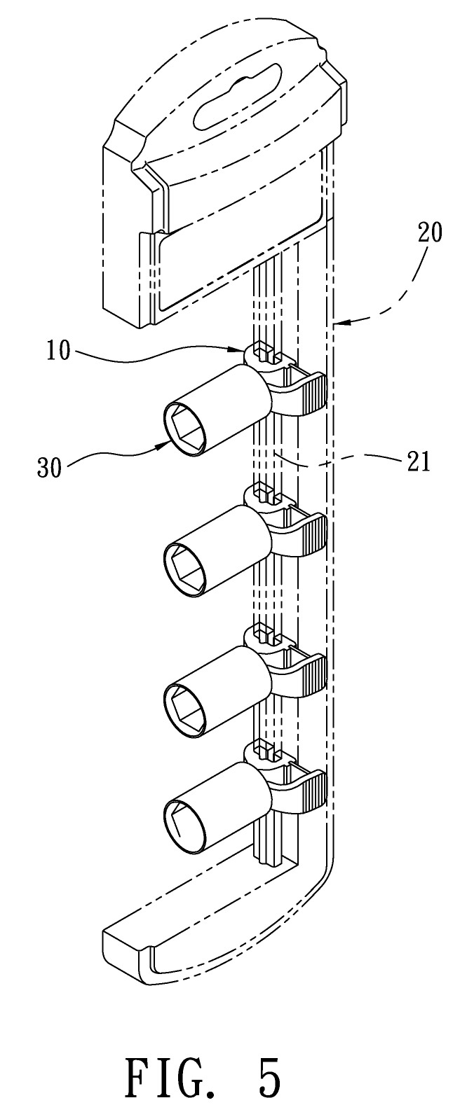

Referring to FIG. 5, four sockets 30 are firmly connected to four holders 10. The dovetail groove 112 of each holder 10 receives a dovetail 21 of a hanger 20 so that the holder 10 is movably connected to the hanger 20. Therefore, the sockets 30 are hung on the hanger 20.

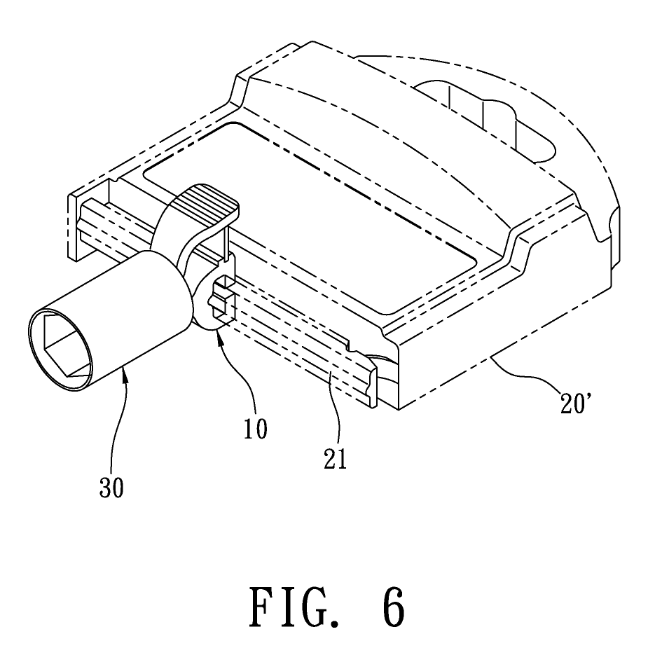

Referring to FIG. 6, a socket 30 is firmly connected to a holder 10. The dovetail groove 112 of the holder 10 receives a dovetail 21 of another hanger 20à so that the holder 10 is movably connected to the hanger 20à. Therefore, the socket 30 is hung on the hanger 20à.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A holder for holding a socket onto a hanger, the holder comprising:
a socket-engaging device comprising:
a V-shaped body comprising a first branch and a second branch elastically movable towards the first branch so that the V-shaped body can be inserted into the socket; and
a block formed on the second branch for abutment against the socket when the V-shaped body is disposed in the socket;
a locking device comprising a recess defined in the first branch of the V-shaped body and an extensive element extended from the second branch of the V-shaped body, wherein the extensive element can be inserted into the recess so that the V-shaped body is expanded, and the block is firmly located against the socket; and
a hanger-engaging device comprising a dovetail groove for receiving a dovetail formed on the hanger.

2. The holder according to claim 1, wherein the extensive element is a tab, and the recess is a groove for receiving the tab.

3. The holder according to claim 1, wherein the locking device comprises a slope formed on the second branch for guiding the extensive element into the recess.

4. The holder according to claim 1, wherein the locking device comprises a button formed on the second branch opposite to the extensive element for the easy maneuvering of the extensive element.

5. The holder according to claim 4, wherein the button comprises grooves defined therein.

6. The holder according to claim 1, wherein the block is in the form of a trapezoid.
